(19) United States
(12) Patent Application Publication
(10) Pub. No.: US 2009/0005583 A1
(43) Pub. Date: Jan. 1, 2009

(54) Preparation of Propylene Glycol Fatty Acid Ester or Other Glycol or Polyol Fatty Acid Esters

(76) Inventor: Herman P. Benecke, Columbus, OH (US)

Correspondence Address: DIEDERIKS & WHITELAW, PLC, 12471 DILLINGHAM SQUARE, #301, WOODBRIDGE, VA, 22192, US

(21) Appl. No.: 12/165,130

(22) Filed: Jun. 30, 2008

Related U.S. Application Data
(60) Provisional application No. 60/947,222, filed on Jun. 29, 2007.

(51) Int. Cl. C11C 3/00

(52) U.S. Cl. 554/168

(57) ABSTRACT

A method for the preparation of a polyol fatty acid ester utilizes a combination of methyl soyate and a polyol in a molar ratio of approximately 2:1 in the presence of a basic catalyst to produce a fatty acid ester. Methanol is removed during a distillation process to drive the reaction process. Optionally, gas sparging can be utilized to aide in methanol recovery. In one embodiment, the method is employed to produce a propylene glycol disoyate product that does not require further purification or distillation to remove a relatively high boiling methyl soyate reactant.

### CROSS-REFERENCE TO RELATED APPLICATIONS

This application claims the benefit of U.S. Provisional Application Ser. No. 60/947,222, filed Jun. 29, 2007 entitled “Preparation of Propylene Glycol Fatty Acid Ester or other Glycol or Polyol Fatty Acid Esters.”

### FIELD OF THE INVENTION

The present invention pertains to the art of fatty acid ester preparation and, more particularly, to the preparation of a propylene glycol fatty acid ester from vegetable oils.

### BACKGROUND OF THE INVENTION

It is known in the art to produce propylene glycol fatty acid esters from a polyol, a fatty acid lower alkyl ester and a basic catalyst as taught, for example, by U.S. Pat. No. 3,963,699, which is hereby incorporated by reference. See also U.S. Pat. No. 6,965,043, hereby incorporated by reference. Such methods require excess amounts of esters to drive the reaction. In the method set forth in the '699 patent, for example, excess fatty acid lower alkyl esters are added to a homogenous melt of a polyol, fatty acid lower alkyl esters, an alkali metal fatty acid soap, and a basic catalyst formed in a first step. The term “excess” includes sufficient lower alkyl esters to raise the overall ester to polyol molar ratio above 10:1, preferably to about 16:1, in accordance with this prior art.

It is also known to produce fatty acid esters from propylene glycol, a fatty acid methyl ester and an alkaline catalyst as taught by U.S. Pat. No. 7,126,018, incorporated herein by reference. For example, one method for producing a soy methyl ester from soybean oil and propylene gylcol in the presence of a lithium carbonate catalyst is set forth in a paper by N. Jiratumnukul and M. R. Van De Mark, J. Am. Oil Chem. Soc. 77: 691 (2000). However, in the approach by Jiratumnukul and Van DeMark to prepare propylene glycol monosoyate from soybean oil and propylene glycol, a significant excess of propylene is used to shift the equilibrium to the product side. In preparing propylene glycol disoyate from methyl or alkyl soyate and propylene glycol, an excess of methyl or alkyl soyate could be used to drive this reaction to the product side. However, the product propylene glycol disoyate would be prepared in the presence of a large excess of methyl soyate and removal of this excess reagent by distillation or other separation approaches would be very difficult.

Epoxidized propylene glycol disoyate has been shown to be a good plasticizer for polyvinyl chloride (PVC). The existing synthesis of epoxidized propylene glycol disoyate involves a three step reaction sequence involving hydrolysis of soybean oil to produce soy acid which is then esterified with propylene glycol to produce propylene glycol disoyate. This material is then epoxidized to form epoxidized propylene glycol disoyate. This process is set forth in U.S. Pat. No. 6,797,753, which is herein incorporated by reference. The strong acid-catalyzed esterification of propylene glycol with soy acid to form propylene glycol disoyate gives a highly colored product. Also, the non-catalyzed reaction of propylene glycol with soy acid performed by distillation of water is a very slow process and the stoichiometry of propylene glycol and soy acid is difficult to match due to co-distillation of partially esterified propylene glycol towards the end of the distillation.

Based on the above, there is seen to exist a need for an alternate and improved method for forming propylene glycol disoyate or other glycol or polyol soy acid esters.

### SUMMARY OF THE INVENTION

The present invention is directed to a method for preparing a fatty acid ester from a vegetable oil and a polyol in the presence of lithium carbonate. More specifically, the present method uses a methyl soyate and a polyol at molar ratios of approximately 2:1 and is driven to near completion by the facile distillation of methanol at much lower temperatures than the distillation temperature of methyl or alkyl soyate. Such a method provides for the diesterification of propylene glycol or other glycol or polyol by transesterification with methyl or other alkyl soyates while using specific catalysts. In addition, the above method advantageously results in a propylene glycol disoyate product that does not require further purification or distillation to remove the relatively high boiling methyl soyate reactant.

Additional objects, features and advantages of the invention will become more readily apparent from the following description of preferred embodiments of the invention.

### DETAILED DESCRIPTION OF THE INVENTION

The present invention is directed to an improved method for forming epoxidized propylene glycol disoyate or other glycol or polyol soy acid esters. The first step involves known and rapid sodium or potassium hydroxide mediated methanolyis of soybean oil to form methyl soyate (and glycerin) as a first intermediate. This reaction proceeds very rapidly at close to ambient temperature and the methyl soyate is obtained in a relatively pure state as a second phase that can be washed and dried as necessary to obtain material appropriate for the subsequent transesterification reaction. Such reactions are known, such that further details of the process need not be discussed in detail.

In accordance with the present invention, the second reaction is an inventive step that involves the transesterification of methyl soyate with a polyol. More specifically, methyl soyate is combined with a polyol at a molar ratio of approximately 2:1 in the presence of a basic catalyst to form a heterogenous mixture, which is then heated to a temperature of between approximately 160° C. and 187° C. Preferably, the mixture is heated to approximately 180° C.

In a preferred embodiment, the polyol is propylene glycol and the basic catalyst is lithium carbonate. For purposes of further detailing the invention, preferred embodiments employing propylene glycol will discussed. In accordance with the invention, it was found that methyl soyate and propylene glycol could be transesterified in the presence of the catalyst lithium carbonate when nearly equivalent quantities of these reagents were employed. That is, a methyl soyate to propylene glycol molar ratio of approximately 2:1 was found effective in producing a propylene glycol fatty acid ester with the present method. At this point, it should be noted that, by “approximately 2:1” it is meant that the ratio is at least 2:1 but no more than 3:1 and, most preferably, very close to 2:1. Concerning the transesterification of methyl soyate with propylene glycol, it was found that sodium carbonate and mixtures of calcium acetate and barium acetate could also be used to catalyze this transesterification, but these were not as effective as lithium carbonate. Sodium methoxide and sulfuric acid were judged not to be appropriate catalysts due to the fact that significant ester condensation occurred with sodium methoxide (presumably via the Claisen ester condensation) and significant decomposition occurred with sulfuric acid.

The equilibrium involving production of propylene glycol disoyate is driven by collecting methanol which is recovered by distillation. In accordance with this principle, it was found that using a distillation apparatus in which the condenser was positioned adjacent to, and more specifically as close as practically possible to, the surface of the heated solution resulted in higher degree of acylation in less time than when using a less efficient distillation apparatus. In further accordance with the invention, the temperature is advantageously increased to a second temperature during the later course of the interesterification after almost all propylene glycol became at least monoacylated, thereby preventing propylene glycol from distilling from the reaction. Furthermore, the use of an inert gas sparge is used advantageously during the latter stages of the interesterification to help drive the interesterification to completion by enhancing removal of methanol.

The following example is intended only to further illustrate the invention, and is not intended to limit the scope of the invention defined in the claims.

### EXAMPLE 1

### Formation of Propylene Glycol Disoyate by Reaction of Propylene Glycol (PG) with One Equivalent of Methyl Soyate (Approximately 2 moles Methyl Soyate Per Mole PG)

A reaction was set up in a 14/20 standard taper 50 ml round bottom flask that was charged with the following materials: propylene glycol (molecular weight 76.10; 2.0547 g; 0.0270 mole), methyl soyate (molecular weight 278.0; 15.312 g; 0.05508 mole, 2% excess), and lithium carbonate (0.1531 g) used as a catalyst. The flask was equipped with a distillation head and the entire system was maintained under an argon atmosphere by using a bubbler system attached to the distillation head. The flask contents were stirred by use of a magnetic stir bar and the system was heated by immersion in an oil bath that was heated on a stirring hot plate. The reaction was maintained under atmospheric pressure and methanol produced in the reaction was collected. Conversion of propylene glycol to propylene glycol 1-soyate (PG 1-soyate), propylene glycol 2-soyate (PG 2-soyate), and propylene glycol disoyate (PG disoyate) was determined by analysis of samples that were removed from the reaction flask at intervals and analyzed by proton nuclear magnetic resonance spectroscopy (NMR) using a 300 MHz NMR spectrometer. Following is a table of internal reaction temperatures and mole and weight percentages of individual species obtained in this reaction:

| Reaction | Reaction | | | Mole % | Weight % | Weight % |
|---|---|---|---|---|---|---|
| Temperature | Time | Mole % | Mole % | PG | PG | PG |
| (° C.) | (hr) | PG 1-soyate | PG 2-soyate | Disoyate | Monosoyate | Disoyate |
| 160 | 30 | 34.72 | 12.94 | 52.35 | 33.77 | 66.23 |
| 183 | 47 | 21.44 | 5.10 | 73.46 | 16.83 | 83.17 |
| 180 | 71 | 14.43 | 3.38 | 82.19 | 10.82 | 89.18 |
| 187 | 101 | 10.14 | 2.65 | 87.21 | 7.59 | 92.41 |

It can be seen from this data that the reaction of propylene glycol with methyl soyate to form propylene glycol disoyate can be driven to near completion by reacting with essentially one equivalent of methyl soyate. Use of a heated inert sparge gas during the latter part of the reaction can been used to remove methanol and drive the reaction to near completion in a shorter time than shown above. Use of heated sparge gas would be performed most advantageously only after esterification of at least one hydroxyl group of propylene glycol (obtained at the latter part of the reaction) to prevent unwanted distillation of propylene glycol from the reaction mixture.

Advantageously, the above method results in a propylene glycol disoyate product that does not require further purification or distillation to remove the relatively high boiling methyl soyate reactant.

In a preferred embodiment, a third step involves the known epoxidation of propylene glycol disoyate to produce epoxidized propylene glycol disoyate using peracids, such as peracetic or performic acid. Such reactions are known, such that further details of this process step need not be discussed in detail.

Although described with reference to preferred embodiments of the invention, it should be readily understood that various changes and/or modification can be made to the invention without departing from the spirit thereof. For example, although the production of methyl disoyate is emphasized, the approach described above can be used to prepare a variety of glycol and polyol derivatives that have been fully esterified with methyl soyate or the short chain alkyl ester of any vegetable oil. In general, the invention is only intended to be limited by the scope of the following claims.

I claim:

1. A method for preparing a polyol fatty acid ester comprising:
combining methyl soyate and a polyol in a ratio of approximately 2:1 in the presence of a basic catalyst to form a mixture;
heating the mixture;
placing a condenser adjacent a surface of the mixture;
distilling the mixture to recover methanol; and
recovering a fatty acid ester from the mixture.

2. The method of claim 1, wherein further purification or distillation to remove a relatively high boiling methyl soyate reactant is not required.

3. The method of claim 1, wherein the polyol is propylene glycol.

4. The method of claim 3, wherein the basic catalyst constitutes lithium carbonate.

5. The method of claim 3, wherein the fatty acid ester is propylene glycol disoyate.

6. The method of claim 5, further comprising epoxidizing the propylene glycol disoyate to produce epoxidized propylene glycol disoyate.

7. The method of claim 1, wherein the basic catalyst selected from the group consisting of lithium carbonate and sodium carbonate.

8. The method of claim 7, wherein the basic catalyst constitutes lithium carbonate.

9. The method of claim 1, wherein the basic catalyst is a mixture of calcium acetate and barium acetate.

10. The method of claim 1, further comprising removing methanol from the mixture utilizing an inert gas sparge.

11. The method of claim 10, wherein the inert gas sparge is heated.

12. The method of claim 11, wherein the heated inert gas sparge is only employed during a latter part of the reaction.

13. The method of claim 12, wherein the polyol is propylene glycol and the heated inert sparge gas is employed only after esterification of at least one hydroxyl group of the propylene glycol.

14. The method of claim 1, further comprising producing the methyl soyate through rapid sodium or potassium hydroxide mediated methanolysis of soybean oil.

15. The method of claim 1, wherein the mixture is heated to a temperature of between 160° C. and 187° C.

16. The method of claim 15, wherein the mixture is heated to approximately 180° C.

17. The method of claim 1, further comprising: placing the condenser as close as possible to the surface of the mixture.
